(19) United States
(12) Patent Application Publication
(10) Pub. No.: US 2009/0038229 A1
(43) Pub. Date: Feb. 12, 2009

(54) MODULAR DROP-GLASS WINDOW ASSEMBLIES

(75) Inventors: Robert John Cicala, Rochester Hills, MI (US); Jeffrey Scott Wilkinson, South Lyon, MI (US)

Correspondence Address: BANNER & WITCOFF, LTD., 28 STATE STREET, 28th FLOOR, BOSTON, MA, 02109-9601, US

(73) Assignee: DURA AUTOMOTIVE SYSTEMS, INC., Rochester Hills, MI (US)

(21) Appl. No.: 11/836,194

(22) Filed: Aug. 9, 2007

(51) Int. Cl. B60J 1/16

(52) U.S. Cl. 49/374

(57) ABSTRACT

Modular drop-glass window assemblies include a vertically slidable pane, at least one stationary pane having an inboard vertical edge proximate to the exterior surface of the slidable pane and framing holding the stationary pane(s) and at least partially defining a window opening that is opened and closed by movement of the slidable pane. The framing includes vertical frame portions defining run channels for guiding the slidable pane between its open and closed positions. No portion of the vertical frame portions extends exteriorly beyond the plane of the exterior surface of a stationary pane.

### FIELD OF THE INVENTION

This invention relates generally to a motor operated vehicle window construction and, in particular, to a modular drop-glass window suitable for use in a motor vehicle.

### BACKGROUND OF THE INVENTION

Motor vehicle window assemblies typically have one or more slidable panes, that is, panes which can slide from a closed position to a full open position, and which may be either manually operated or operated by an electric motor. Such window assemblies are used, for example, as rear slider windows for pickup truck cabs to increase airflow into the motor vehicle. Typically such rear slider windows have a circumferential (that is, outer peripheral) frame in which the slidable pane is mounted along with one or more stationary panes. The frame may be structural or semi-structural in that it integrates the slidable pane and one or more stationary panes as a self-contained preassembled module suitable for shipping and handling prior to installation into a motor vehicle.

Sliding window assemblies are increasingly popular, particularly when used for backlights in pickup trucks. A power window assembly for a vehicle having a slidable pane is shown in U.S. Pat. No. 5,724,769 to Cripe et al. Cripe et al is a robust design for a pull-pull power sliding window assembly having left and right stationary panes and a horizontally sliding center pane sliding between upper and lower run channels. A drive motor, drive drum and drive cable pull the slidable pane back and forth in a manner similar to conventional cable drum window regulators. Cable directional blocks route drive cable from below the frame to a lower horizontal peripheral edge of the slidable pane. Such a design advantageously routes the cables so as to avoid excessive drag associated with pulling the slidable pane up against the upper run channel or down against the lower run channel

It would be desirable to provide a drop-glass window suitable for use in a motor vehicle that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide modular drop-glass window suitable for use in a motor vehicle. In accordance with a first aspect, a modular drop-glass window assembly includes a vertically slidable pane having an interior surface and an exterior surface. A first stationary pane has a peripheral edge including an inboard vertical edge proximate to the exterior surface of the vertically slidable pane and an exterior surface. A second stationary pane has a peripheral edge including an inboard vertical edge proximate to the exterior surface of the vertically slidable pane and an exterior surface. Framing holds the first and second stationary panes in a spaced relationship and at least partially defines a window opening therebetween. The framing includes at least first and second vertical frame portions of polymeric material defining first and second run channels, respectively, for receiving first and second vertical edges, respectively, of the slidable pane for guiding vertical movement of the slidable pane between a closed position in the window opening and an open position. No portion of the first vertical frame portion extends exteriorly beyond a plane of the exterior surface of the first stationary pane, and no portion of the second vertical frame portion extends exteriorly beyond a plane of the exterior surface of the second stationary pane.

In accordance with another aspect, a motor vehicle modular drop-glass window assembly includes a vertically slidable pane having an interior surface and an exterior surface. A first stationary pane has a peripheral edge including an inboard vertical edge and an exterior surface. Framing of polymeric material at least partly mounts the first stationary pane and the vertically slidable pane and at least partially defines a window opening adjacent to the inboard vertical edge of the first stationary pane. The framing includes at least first and second vertical frame portions of polymeric material defining first and second run channels, respectively, with each run channel being open toward the other run channel for receiving first and second vertical edges, respectively, of the slidable pane for guiding vertical movement of the slidable pane between a closed position in the window opening and an open position. The first vertical frame portion has an exterior surface adjacent to and flush with the exterior surface of the first stationary pane at the inboard vertical edge of the first stationary pane. A periphery extension of polymeric material is molded along at least a portion of the peripheral edge other than at the first vertical frame portion. An elongate lower horizontal portion extends horizontally below the window opening at least from the first vertical frame portion to the second vertical frame portion, with the vertically slidable pane being vertically slidable from the open position to the closed position inwardly of the elongate horizontal portion of the framing. An elongate upper horizontal header extends at least between the first and second vertical frame portions. Drive means moves the slidable pane between the open position and the closed position. No portion of the first vertical frame portion extends exteriorly beyond a plane of the exterior surface of the first vertical frame portion, and no portion of the first periphery extension extends exteriorly beyond a plane of the exterior surface of the first periphery extension. The first and second run channels are positioned interiorly of and laterally behind the first vertical frame portion, and the lateral dimension of the exterior surface of each of the first and second vertical frame portions is approximately 2-3 mm at its widest point.

In accordance with a further aspect, a motor vehicle modular drop-glass window assembly includes a vertically slidable pane having an interior surface and an exterior surface. A first stationary pane has a peripheral edge including an inboard vertical edge and an exterior surface. A second stationary pane has a peripheral edge including an inboard vertical edge and an exterior surface. Framing of polymeric material at least partly mounts the first and second stationary panes and the vertically slidable pane and at least partially defines a window opening adjacent to the inboard vertical edges of the first and second stationary panes. The framing includes at least first and second vertical frame portions of polymeric material defining first and second run channels, respectively, with each run channel being open toward the other run channel for receiving first and second vertical edges, respectively, of the slidable pane for guiding vertical movement of the slidable pane between a closed position in the window opening and an open position. The first vertical frame portion has an exterior surface adjacent to and flush with the exterior surface of the first stationary pane at the inboard vertical edge of the first stationary pane. The second vertical frame portion has an exterior surface adjacent to and flush with the exterior surface of the second stationary pane at the inboard vertical edge of the second stationary pane. A periphery extension of polymeric material is molded along at least a portion of the peripheral edge of each of the first and second stationary panes other than at the first and second vertical frame portions. An elongate lower horizontal portion extends horizontally below the window opening at least from the first vertical frame portion to the second vertical frame portion. The vertically slidable pane is vertically slidable from the open position to the closed position inwardly of the elongate horizontal portion of the framing. An elongate upper horizontal header extends at least between the first and second vertical frame portions. Drive means moves the slidable pane between the open position and the closed position. No portion of the first vertical frame portion extends exteriorly beyond a plane of the exterior surface of the first vertical frame portion. No portion of the second vertical frame portion extends exteriorly beyond a plane of the exterior surface of the second vertical frame portion. No portion of the first periphery extension extends exteriorly beyond a plane of the exterior surface of the first periphery extension. The first and second run channels are positioned interiorly of and laterally behind the first and second stationary panes. The lateral dimension of the exterior surface of each of the first and second vertical frame portions is approximately 2-3 mm at its widest point.

Substantial advantage is achieved by providing a modular drop-glass window suitable for use in a motor vehicle. In particular, certain embodiments provide a raw edge-of-glass appearance around the stationary panes of the window assembly and provide a minimal vertical frame portion appearance. Such an assembly provides a flush transition with the stationary panes, roof, pillar, and belt surfaces.

These and additional features and advantages disclosed here will be further understood from the following detailed disclosure of certain embodiments.

### BRIEF DESCRIPTION OF THE DRAWINGS

FIG. 1 is an inboard elevation view of a modular drop-glass window assembly.

FIG. 2 is an outboard perspective view of the modular drop-glass window assembly of FIG. 1, with the drive mechanism not shown, shown being installed in a motor vehicle.

FIG. 3 is a section view of the header of the modular drop-glass window assembly of FIG. 1, taken along line 3-3 of FIG. 1

FIG. 4 is a second view of the beltline of the modular drop-glass window assembly of FIG. 1, taken along line 4-4 of FIG. 1.

FIG. 5 is a section view of a portion of the framing of the modular drop-glass window assembly of FIG. 1, taken along line 5-5 of FIG. 2.

FIG. 6 is a section view of a portion of the framing of the modular drop-glass window assembly of FIG. 1, taken along line 6-6 of FIG. 2.

FIG. 7 is a section view of an alternative embodiment of the portion of the framing of the modular drop-glass window assembly of FIG. 1 shown in FIG. 6.

FIG. 8 is a section view of a portion of the framing of an alternative embodiment of the modular drop-glass window assembly of FIG. 1.

The figures referred to above are not drawn necessarily to scale, should be understood to provide a representation of particular embodiments of the invention, and are merely conceptual in nature and illustrative of the principles involved. Some features of the modular drop-glass window depicted in the drawings have been enlarged or distorted relative to others to facilitate explanation and understanding. The same reference numbers are used in the drawings for similar or identical components and features shown in various alternative embodiments. Modular drop-glass windows as disclosed herein would have configurations and components determined, in part, by the intended application and environment in which they are used.

### DETAILED DESCRIPTION OF CERTAIN PREFERRED EMBODIMENTS

It will be apparent to those skilled in the art, that is, to those who have knowledge or experience in this area of technology, that many uses and design variations are possible for the modular drop-glass window disclosed here. The following detailed discussion of various alternative and preferred features and embodiments will illustrate the general principles of the invention with reference to a drop-glass sliding window module for use closing an opening in the back of a motor vehicle, such as a pickup truck or a sport utility vehicle (SUV). Other embodiments suitable for other applications will be apparent to those skilled in the art given the benefit of this disclosure.

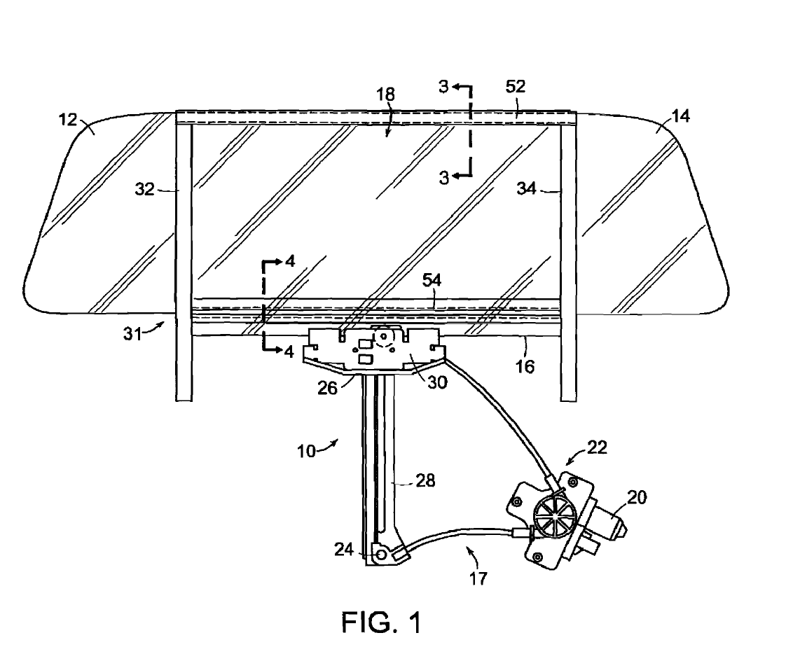

Referring now to the drawings, FIG. 1 shows a preferred embodiment of a modular drop-glass sliding window assembly 10. By the term “modular” or “module” it is meant that the window assembly is structurally self-supporting even as a pre-assembled unit prior to installation into a motor vehicle. Window assembly 10 has a first stationary pane 12 and a second stationary pane 14 positioned on either side of a slidable pane 16. The panes 12-16 are typically made of either a generally transparent glass or plastic such as a polycarbonate. A drive mechanism 17, such as a cable-drum window regulator, moves the slidable pane 16 between a full open position and a closed position. The slidable pane 16 closes a central air opening 18 when in the closed position. In the full open position, sliding pane 16 preferably, but not necessarily is dropped entirely out of the central opening.

The term “inboard” is used here (i.e., in this description of the disclosed window assemblies and in the appended claims) to describe a lateral position or location, e.g., the location of the vertical edge of one of stationary panes 12, 14, which is proximate to stationary pane 16. As viewed in FIG. 1, for example, inboard refers to the lateral position of a feature, i.e., the position from right-to-left in the window assembly embodiment as shown in that drawing. Thus, the inboard vertical edge of left-side stationary pane 12 is the right edge of that pane. Likewise, the inboard vertical edge of right-side stationary pane 14 is the left edge of that pane. Correspondingly, an outboard side, edge or surface is laterally away from the inboard side, edge or surface. Thus, the outboard vertical edge of left-side stationary pane 12 is the left edge of that pane, and the outboard vertical edge of right-side stationary pane 14 is the right edge of that pane.

The terms top, up (or upward, etc.) and down (or downward, etc.) refer generally to the directions of travel of slidable pane 16 toward the closed position or the open position, respectively. Thus, in the window assembly embodiment as shown in FIG. 1, up is generally toward the top of the page and down is toward the bottom of the page. Correspondingly, the terms bottom, lower or the like refer generally to a position or location below or downward from a reference point, and the terms top or upper or the like refer generally to a position or location above or upward from a reference point.

It should be understood that reference here to a plane, e.g., the plane of travel of slidable pane 16, is intended to broadly cover true planes, i.e., simple flat surfaces or imaginary spaces, as well as curvo-planar surfaces and shapes (e.g., similar to the surface of a typical motor vehicle's roof or fender) and multi-planar surfaces and shapes where the multiple planes are fairly viewed as all being parts of a larger, generally planar or curvo-planar surface or shape. In certain exemplary embodiments, for example, each of stationary panes 12, 14 may be curved, perhaps having a surface which is a complex curve, but which nevertheless is fairly seen to be generally planar (in this instance generally curvo-planar). Similarly, each of the pair of laterally spaced, curvo-planar stationary panes 12, 14 flanking slidable pane 16 in FIG. 1 is in the same plane as that term is used here.

The terms interior and exterior or inside and outside are used here to refer generally to the front and back of the window assembly. Thus, the exterior side or surface of the window assembly embodiment shown in FIG. 1 is the side viewed in the drawing and the interior side or surface is the opposite side, i.e., the side facing away from the viewer. In automotive applications, for example, the interior or inside of the window assembly is the side facing into the passenger compartment (or designed, when installed, to face into the passenger compartment). Correspondingly, the exterior faces outwardly, e.g., to the weather.

Drive mechanism 17 includes a motor 20, a cable-drum assembly 22, and pulleys 24 (or sliders) for routing the cable to a glider 26 which slides up and down over a rail 28. Glider 26 slides up and down over rail 28 in response to tension from the cable-drum assembly produced by actuation of motor 20, and glider 26 is attached to a slidable pane attachment bracket 30, which is in turn attached to slidable pane 16. It is to be appreciated that any known drive mechanism could be used to drive slidable pane 16.

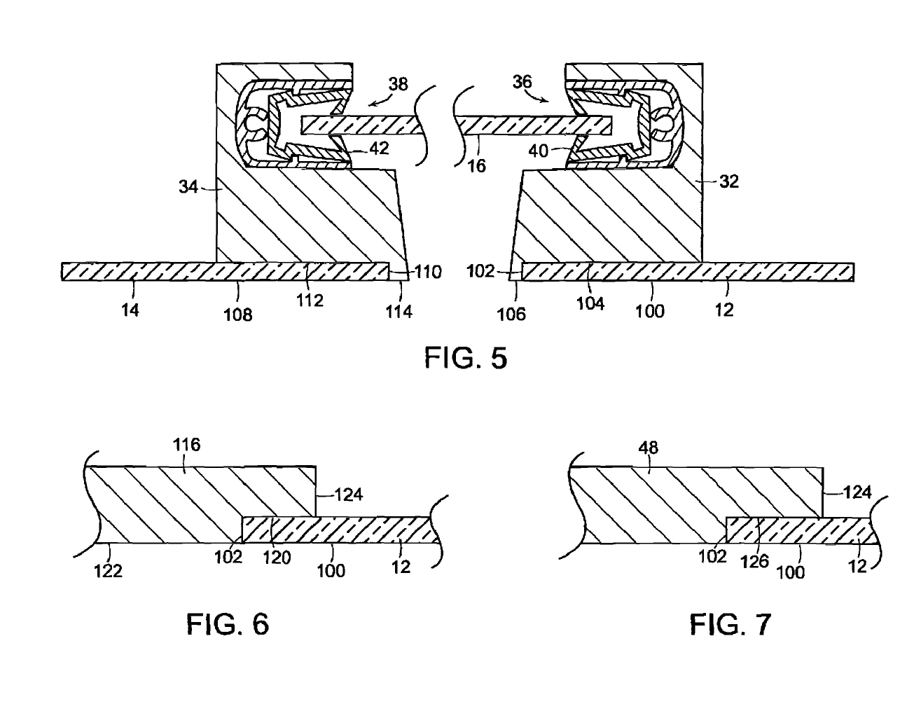

Framing 31 for window assembly 10 includes first and second vertical frame portions, such as left and right division bars 32, 34, which are positioned on either side of slidable pane 16, in between slidable pane 16 and each of stationary panes 12, 14. Division bars 32, 34 are formed of a polymeric material such as polyvinylchloride (PVC), or a reaction injection molded polyurethane (RIM). Each division bar 32, 34 defines a corresponding run channel 36, 38 which receives a corresponding vertical edge of slidable pane 16, seen in FIG. 5. Each run channel 36, 38 has a corresponding run channel seal 40, 42. Framing 31 includes a top segment 48 and a bottom segment 50.

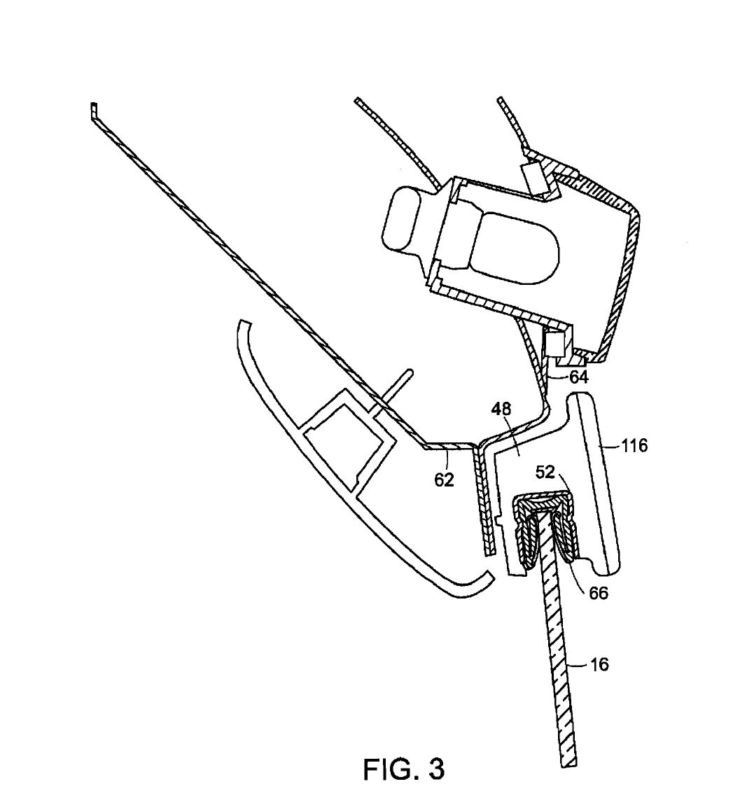

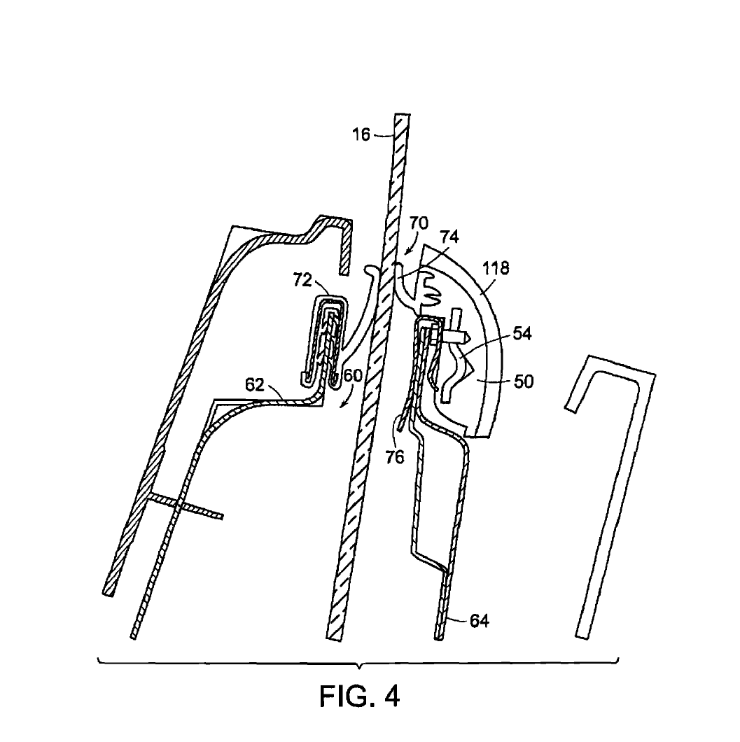

Framing 31 includes a header 52 and a beltline support 54. The header 52 is attached to both division bars 32, 34 at top ends thereof, and beltline support 54 is attached to both division bars 32, 34 at bottom ends thereof. Header 52 is shown in cross section in FIG. 3 and beltline support 54 is shown in the cross sectional view of FIG. 4. Header 52 and beltline support 54 may be screwed, riveted, or otherwise fastened to left and right division bars 32, 34 to form framing 31.

For ease of assembly, preferably the stationary panes 12 and 14, and the skeletal framework are inserted into a mold, and the frame is then injected or “shot” around these components, adhesively bonding to the division bars, 32 and 34, the header 52, the beltline support 54 and the stationary panes 12 and 14. Header 52 and beltline support 54 can be formed of, for example, PVC or RIM. Mounting studs may be used to secure elements of frame 31 together in certain embodiments.

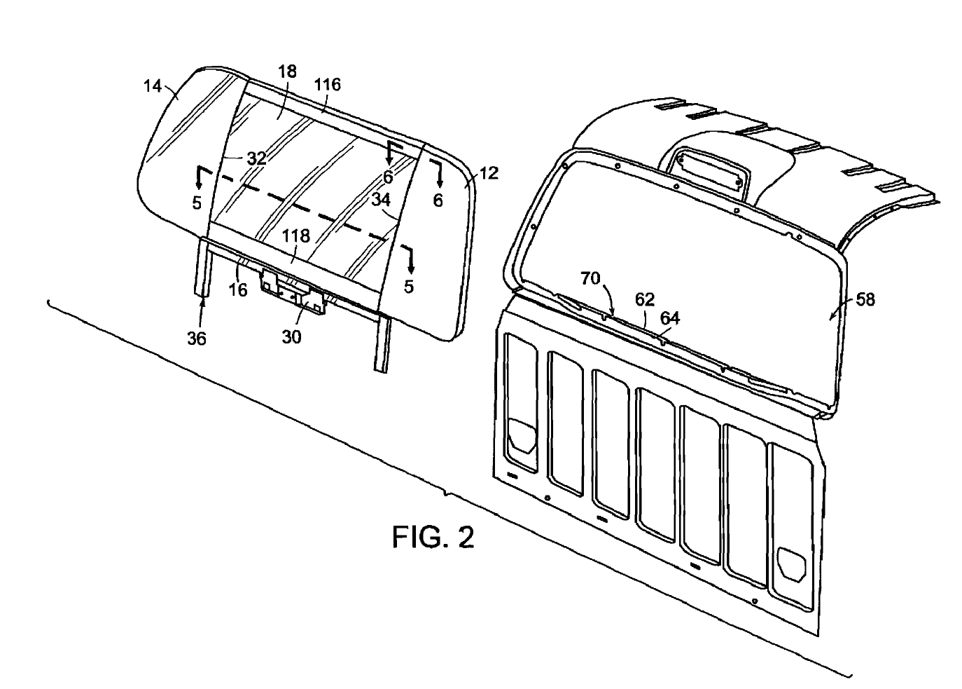

FIG. 2 shows a preferred embodiment with the motor and cable-drum assembly removed for clarity of illustration where the preassembled module 10 can close a back cavity 58 in a motor vehicle. The drop-glass module 10 is attached to the motor vehicle with mounting studs extending from the encapsulation material of the frame 44, by adhesives, or by a combination thereof. Slidable pane 16 advantageously drops into a pocket 60 between an inner panel 62 and an outer panel 64 of the motor vehicle when slidable pane is moving to the full open position. This has the advantageous effect of greatly increasing the allowable size of central air opening 18 without having slidable pane 16 extend laterally beyond the body of the motor vehicle.

Header 52 is, an elongate member with a generally C-shaped cross section at least partially encapsulated by top member 48, as shown in FIG. 3. A header seal 66 is inserted into header 52. Slidable pane 16 dead ends at header 52 as it moves to the closed position, closing central air opening 18.

FIG. 4 shows the beltline support 54 entirely encapsulated by the bottom segment 50 of the frame 44. The beltline support 54 enhances overall structural rigidity of the drop-glass module 10 and serves also to back up the outer panel 64 of the motor vehicle. Note that in the preferred embodiment shown in the drawings, the slidable pane 16 does not actually slide through an opening in the frame. Rather, the slidable pane slides on the inboard side of the bottom segment 50 of the frame into the pocket 60 through a slot 70 between inner beltline seal 72 attached to the motor vehicle body inner panel 62 and outer beltline seal 74 attached to the frame. Preferably the division bars also extend from the top segment 48 of the circumference of the frame 44 to below the bottom segment 50 of the circumference of the frame.

For ease of installation of the module into a motor vehicle body opening, a guidance clip 76 may be affixed to the bottom segment of the frame 44. The clip 76 serves as a temporary locator to guide the module into its installation position by snugly fitting over the outer panel 64, permitting attachment and alignment.

The header seal 66, shown in FIG. 3, and the outer beltline seal 74 shown in FIG. 4 cooperate with left and right run channel seals 40, 42 to form an outside seal assembly to seal the central opening 18 when the slidable pane is in the closed position, thereby preventing water, dirt and other elements from entering the motor vehicle.

As seen in FIG. 5, first stationary pane 12 has an exterior surface 100 and a peripheral edge including an inboard vertical edge 102. A rabbet 104 is formed at an exterior surface 106 of left division bar 32 such that exterior surface 100 of first stationary pane 12 is adjacent and flush with exterior surface 106 of left division bar 32. In certain embodiments, no portion of left division bar 32 extends exteriorly beyond a plane of exterior surface 106 of left division bar 32.

In certain embodiments, the lateral dimension of exterior surface 106 of left division bar 32, that is, its dimension between inboard vertical edge 102 of first stationary pane 12 and the inboard vertical edge of left division bar 32 is at least 2-3 mm at its narrowest point.

In certain embodiments, first run channel 36 and rabbet 104 are formed at least in part in the same unitary body of polymeric material, which in the illustrated embodiment is left division bar 32. Similarly, in certain embodiments, second run channel 38 and rabbet 112 are formed at least in part in the same unitary body of polymeric material, which in the illustrated embodiment is right division bar 34. First run channel 36 and second run channel 38 are positioned interiorly of and laterally behind first and second stationary panes 12, 14, respectively.

Second stationary pane 14 has an exterior surface 108 and a peripheral edge including an inboard vertical edge 110. A rabbet 112 is formed at an exterior surface 114 of right division bar 34 such that exterior surface 108 of second stationary pane 14 is adjacent and flush with exterior surface 114 of right division bar 34. In certain embodiments, no portion of right division bar 34 extends exteriorly beyond a plane of exterior surface 114 of right division bar 34.

In certain embodiments, the lateral dimension of exterior surface 114 of right division bar 34, that is, its dimension between inboard vertical edge 110 of second stationary pane 14 and the inboard vertical edge of right division bar 34 is approximately 2-3 mm at its narrowest point.

In certain embodiments, as seen in FIG. 2, first and second stationary panes 12, 14 have at least one raw edge other than at left division bar 32 and right division bar 34, respectively. In certain embodiments, first stationary pane 12 and second stationary pane 14 are mounted without holes extending therethrough, such that framing 31 and mounting means such as adhesive about stationary panes 12, 14 retains the panes within opening 18.

Periphery extensions may be positioned along the peripheral edges of stationary panes 12, 14 at locations other than at left and right division bars 32, 34. In certain embodiments, as seen in FIGS. 2-4 and 6, a first elongate appliqué 116 extends along an upper edge of slidable pane 16. Similarly, a second elongate appliqué 118 extends along a lower edge of slidable pane 16.

A rabbet 120 is formed in each end of first elongate appliqué 116 and second elongate appliqué 118, along its exterior surface 122 proximate its outboard vertical edge 124 (illustrated in FIG. 6 with respect to one end of first elongate appliqué 116 only, with its second end and those of second elongate appliqué 118 having a similar construction). Each rabbet 120 receives the inboard vertical edge 102, 110 of the corresponding stationary pane 12, 14 such that exterior surface 122 of the appliqué is substantially flush with the exterior surface 100, 108 of stationary panes 12, 14.

The exterior surfaces of first and second appliqués 116, 118, being substantially flush with the exterior surfaces 100, 108 of first and second stationary panes 12, 14, respectively, are also substantially flush with the exterior surfaces 106, 114 of left and right division bars 32, 34.

In certain embodiments, top segment 48 and bottom segment 50 are formed of a polymeric material such as polyvinylchloride (PVC), or a reaction injection molded polyurethane (RIM). Other suitable materials for top segment 48 and bottom segment 50 will become readily apparent to those skilled in the art, given the benefit of this disclosure.

In certain embodiments, first and second appliqués 116, 118 are formed of a thermoplastic acrylic polycarbonate, forming a high gloss decorative finish for window assembly 10. Other suitable materials for first and second appliqués 116, 118 will become readily apparent to those skilled in the art, given the benefit of this disclosure.

In certain embodiments, as illustrated in FIG. 7, there are no appliqués secured to top segment 48 and/or bottom segment 50. In such an embodiment, a rabbet 126 is formed in each end of top segment 48 and bottom segment 50, along their exterior surfaces proximate their outboard vertical edge 124 (illustrated in FIG. 7 with respect to one end of top segment 48 only; its second end and those of bottom segment 50 having a similar construction). Each rabbet 126 receives the inboard vertical edge 102, 110 of the corresponding stationary pane 12, 14 such that the exterior surface of top segment 48, bottom segment 50 is substantially flush with the exterior surface 100, 108 of stationary panes 12, 14.

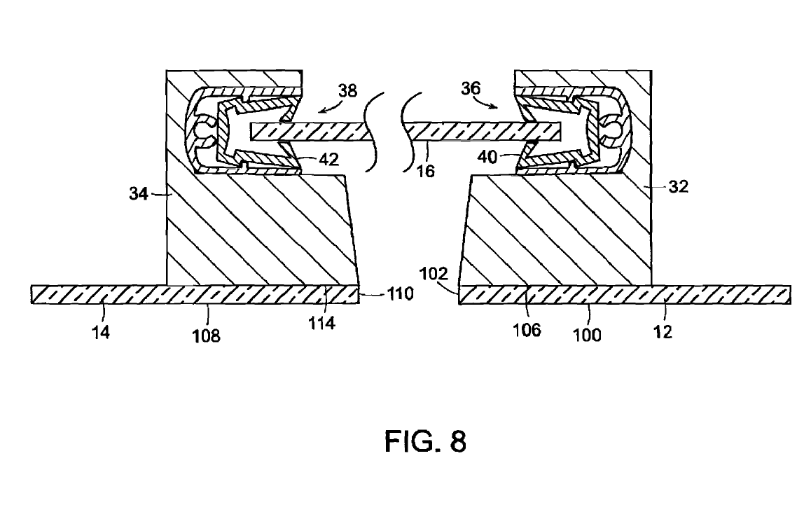

An alternative embodiment is seen in FIG. 8 in which first stationary pane 12 is secured directly to exterior surface 106 of left division bar 32. Similarly, second stationary pane 14 is secured directly to exterior surface 114 of right division bar 34. In this embodiment, therefore, first and second stationary panes 12, 14 have a raw edge of glass appearance from the exterior of the vehicle.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. A modular drop-glass window assembly comprising:
a vertically slidable pane having an interior surface and an exterior surface;
a first stationary pane having
a peripheral edge including an inboard vertical edge proximate to the exterior surface of the vertically slidable pane and
an exterior surface;
a second stationary pane having
a peripheral edge including an inboard vertical edge proximate to the exterior surface of the vertically slidable pane and
an exterior surface; and
framing holding the first and second stationary panes in a spaced relationship and at least partially defining a window opening therebetween,
wherein the framing includes first and second vertical frame portions of polymeric material defining first and second run channels, respectively, for receiving first and second vertical edges, respectively, of the slidable pane for guiding vertical movement of the slidable pane between a closed position in the window opening and an open position,
no portion of the first vertical frame portion extends exteriorly beyond a plane of the exterior surface of the first stationary pane, and
no portion of the second vertical frame portion extends exteriorly beyond a plane of the exterior surface of the second stationary pane.

2. The modular drop-glass window assembly of claim 1, wherein
the first vertical frame portion has an exterior surface adjacent to and flush with the exterior surface of the first stationary pane at the inboard vertical edge of the first stationary pane, and
the second vertical frame portion has an exterior surface adjacent to and flush with the exterior surface of the second stationary pane at the inboard vertical edge of the second stationary pane.

3. The modular drop-glass window assembly of claim 1, wherein
the first run channel is positioned interiorly of and laterally behind the first stationary pane, and
the second run channel is positioned interiorly of and laterally behind the second stationary pane.

4. The modular drop-glass window assembly of claim 1, wherein
the first stationary pane at its inboard edge is seated in a rabbet formed at the exterior surface of the first vertical frame portion, and
the second stationary pane at its inboard edge is seated in a rabbet formed at the exterior surface of the second vertical frame portion.

5. The modular drop-glass window assembly of claim 4, wherein
the first run channel and the rabbet of the first vertical frame portion both are formed at least in part in the same unitary body of polymeric material, and
the second run channel and the rabbet of the second vertical frame portion both are formed at least in part in the same unitary body of polymeric material.

6. The modular drop-glass window assembly of claim 1, wherein the first and second stationary panes are mounted without holes therethrough.

7. The modular drop-glass window assembly of claim 1, wherein the lateral dimension of the exterior surface of the first and second vertical frame portions each is approximately 2-3 mm at its widest point.

8. The modular drop-glass window assembly of claim 1, wherein the lateral dimension of the exterior surface of the first and second vertical frame portions each is approximately 2-3 mm at its narrowest point.

9. The modular drop-glass window assembly of claim 1, wherein the first stationary pane has a raw edge other than at the first vertical frame portion and the second stationary pane has a raw edge other than at the second vertical frame portion.

10. The modular drop-glass window assembly of claim 1, wherein the framing further comprises:
a first periphery extension along the peripheral edge of the first stationary pane other than at the first vertical frame portion, and
a second periphery extension along the peripheral edge of the second stationary pane other than at the second vertical frame portion.

11. The modular drop-glass window assembly of claim 10, wherein the first and second periphery extensions are formed of polymeric material.

12. The modular drop-glass window assembly of claim 10, wherein
the peripheral edge of the first stationary pane other than at the first vertical frame portion is seated in a rabbet formed by the first periphery extension, and
the peripheral edge of the second stationary pane other than at the second vertical frame portion is seated in a rabbet formed by the second periphery extension.

13. The modular drop-glass window assembly of claim 10, wherein
the first periphery extension has a first exterior periphery extension surface adjacent to and flush with the exterior surface of the first stationary pane at the first periphery extension, and
the second periphery extension has a second exterior periphery extension surface adjacent to and flush with the exterior surface of the second stationary pane at the second periphery extension.

14. The modular drop-glass window assembly of claim 10, wherein
no portion of the first periphery extension extends exteriorly beyond a plane of the exterior surface of the first vertical frame portion, and
no portion of the second periphery extension extends exteriorly beyond a plane of the exterior surface of the second vertical frame portion.

15. The modular drop-glass window assembly of claim 1, further comprising an elongate appliqué extending laterally across the vertically slidable pane.

16. The modular drop-glass window assembly of claim 1, further comprising
a first elongate appliqué extending laterally along an upper peripheral edge of the vertically slidable pane, and
a second elongate appliqué extending laterally along the vertically slidable pane below the first elongate appliqué.

17. The modular drop-glass window assembly of claim 1, wherein
the framing further comprises an elongate horizontal portion extending horizontally below the window opening at least from the first vertical frame portion to the second vertical frame portion, and
the vertically slidable pane is vertically slidable from the open position to the closed position inwardly of the elongate horizontal portion of the framing.

18. A motor vehicle modular drop-glass window assembly comprising:
a vertically slidable pane having an interior surface and an exterior surface;
a first stationary pane having
a peripheral edge including an inboard vertical edge, and
an exterior surface;
framing of polymeric material at least partly mounting the first stationary pane and the vertically slidable pane and at least partially defining a window opening adjacent to the inboard vertical edge of the first stationary pane, the framing including at least first and second vertical frame portions of polymeric material defining first and second run channels, respectively, each run channel being open toward the other run channel for receiving first and second vertical edges, respectively, of the slidable pane for guiding vertical movement of the slidable pane between a closed position in the window opening and an open position, the first vertical frame portion having an exterior surface adjacent to and flush with the exterior surface of the first stationary pane at the inboard vertical edge of the first stationary pane; and
a periphery extension of polymeric material molded along at least a portion of the peripheral edge other than at the first vertical frame portion;
an elongate lower horizontal portion extending horizontally below the window opening at least from the first vertical frame portion to the second vertical frame portion, the vertically slidable pane being vertically slidable from the open position to the closed position inwardly of the elongate horizontal portion of the framing;
an elongate upper horizontal header extending at least between the first and second vertical frame portions, and
drive means for moving the slidable pane between the open position and the closed position;
wherein no portion of the first vertical frame portion extends exteriorly beyond a plane of the exterior surface of the first vertical frame portion, no portion of the first periphery extension extends exteriorly beyond a plane of the exterior surface of the first periphery extension, the first and second run channels are positioned interiorly of and laterally behind the first vertical frame portion, and the lateral dimension of the exterior surface of each of the first and second vertical frame portions is approximately 2-3 mm at its widest point.

19. A motor vehicle modular drop-glass window assembly comprising:
a vertically slidable pane having an interior surface and an exterior surface;
a first stationary pane having
a peripheral edge including an inboard vertical edge, and
an exterior surface;
a second stationary pane having
a peripheral edge including an inboard vertical edge; and
an exterior surface;
framing of polymeric material at least partly mounting the first and second stationary panes and the vertically slidable pane and at least partially defining a window opening adjacent to the inboard vertical edges of the first and second stationary panes, the framing including at least first and second vertical frame portions of polymeric material defining first and second run channels, respectively, each run channel being open toward the other run channel for receiving first and second vertical edges, respectively, of the slidable pane for guiding vertical movement of the slidable pane between a closed position in the window opening and an open position, the first vertical frame portion having an exterior surface adjacent to and flush with the exterior surface of the first stationary pane at the inboard vertical edge of the first stationary pane, the second vertical frame portion having an exterior surface adjacent to and flush with the exterior surface of the second stationary pane at the inboard vertical edge of the second stationary pane; and
a periphery extension of polymeric material molded along at least a portion of the peripheral edge of each of the first and second stationary panes other than at the first and second vertical frame portions;
an elongate lower horizontal portion extending horizontally below the window opening at least from the first vertical frame portion to the second vertical frame portion, the vertically slidable pane being vertically slidable from the open position to the closed position inwardly of the elongate horizontal portion of the framing;
an elongate upper horizontal header extending at least between the first and second vertical frame portions, and
drive means for moving the slidable pane between the open position and the closed position;
wherein no portion of the first vertical frame portion extends exteriorly beyond a plane of the exterior surface of the first vertical frame portion, no portion of the second vertical frame portion extends exteriorly beyond a plane of the exterior surface of the second vertical frame portion, no portion of the first periphery extension extends exteriorly beyond a plane of the exterior surface of the first periphery extension, the first and second run channels are positioned interiorly of and laterally behind the first and second stationary panes, and the lateral dimension of the exterior surface of each of the first and second vertical frame portions is approximately 2-3 mm at its widest point.

20. The motor vehicle modular drop-glass window assembly of claim 19, wherein the first and second run channels are offset with respect to the plane of the first and second stationary panes such that the slidable pane moves in a plane offset from and non-parallel to the plane of the first and second stationary panes.

21. A modular drop-glass window assembly comprising:
a vertically slidable pane having an interior surface and an exterior surface;
at least one stationary pane having
a peripheral edge including an inboard vertical edge proximate to the exterior surface of the vertically slidable pane and
an exterior surface; and
framing holding the stationary panes in a spaced relationship and at least partially defining a window opening,
wherein the framing includes first and second vertical frame portions of polymeric material defining first and second run channels, respectively, for receiving first and second vertical edges, respectively, of the slidable pane for guiding vertical movement of the slidable pane between a closed position in the window opening and an open position,
no portion of the first vertical frame portion extends exteriorly beyond a plane of the exterior surface of one of the stationary panes, and
no portion of the second vertical frame portion extends exteriorly beyond a plane of the exterior surface of one of the stationary panes.

22. The modular drop-glass window assembly of claim 21, further comprising first and second stationary panes and wherein the first vertical frame portion has an exterior surface adjacent to and flush with an exterior surface of the first stationary pane at an inboard vertical edge of the first stationary pane, and
the second vertical frame portion has an exterior surface adjacent to and flush with an exterior surface of the second stationary pane at an inboard vertical edge of the second stationary pane.
